(19) United States
(12) Patent Application Publication
(10) Pub. No.: US 2012/0118209 A1
(43) Pub. Date: May 17, 2012

(54) Apparatuses and Methods for Handicapped-Accessible Elevated Garden Units

(76) Inventor: Roy Meiske, Cameron, TX (US)

(21) Appl. No.: 13/020,649

(22) Filed: Feb. 3, 2011

Related U.S. Application Data
(60) Provisional application No. 61/301,701, filed on Feb. 5, 2010.

(51) Int. Cl. A47B 37/00; A01G 9/02

(52) U.S. Cl. 108/28

(57) ABSTRACT

An elevated or raised table provides one or more tabletop compartments that hold potting soil for gardening. Specific embodiments are elevated sufficiently to accommodate a wheelchair under the tabletop. In specific exemplary embodiments, the floor of each compartment comprises a screen or mesh surface for water drainage. Specific embodiments provide disassembled legs that fit into one of the compartments to facilitate shipping. The components, such as the legs, of the various embodiments may be provided in a disassembled and packaged state for ease of shipping and retailing and final assembly by the consumer or user.

### CROSS-REFERENCE TO RELATED APPLICATIONS

This application relates to, claims priority from and the benefit of co-pending U.S. provisional patent application of the same title and by the same inventor,” Ser. No. 61/301,701, filed Feb. 5, 2010, the disclosure of which provisional application is incorporated herein by reference as if set forth in full.

### TECHNICAL FIELD

This disclosure relates generally to tables and more particularly to elevated gardening tables accessible to a handicapped person in a wheelchair or for urban environments.

### BACKGROUND

U.S. Pat. No. 6,349,006 describes a handicapped accessible garden table with recesses to receive plant containers.

### SUMMARY

An elevated or raised table provides one or more tabletop compartments that hold potting soil for gardening. Specific embodiments are elevated sufficiently to accommodate a wheelchair under the tabletop. In specific exemplary embodiments, the floor of each compartment comprises a screen or mesh surface for water drainage. Specific embodiments provide disassembled legs that fit into one of the compartments to facilitate shipping. The components, such as the legs, of the various embodiments may be provided in a disassembled and packaged state for ease of shipping and retailing and final assembly by the consumer or user.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of a specific exemplary embodiment of an elevated garden table of the present disclosure.

FIG. 2 is a diagrammatic illustration of an alternative top view of the elevated garden table of FIG. 1.

FIG. 3A is a diagrammatic illustration of a bottom view of a specific exemplary embodiment of an elevated garden table of the present disclosure.

FIG. 3B is a blow up cut away illustrating a detail of the table of FIG. 3A.

### DETAILED DESCRIPTION

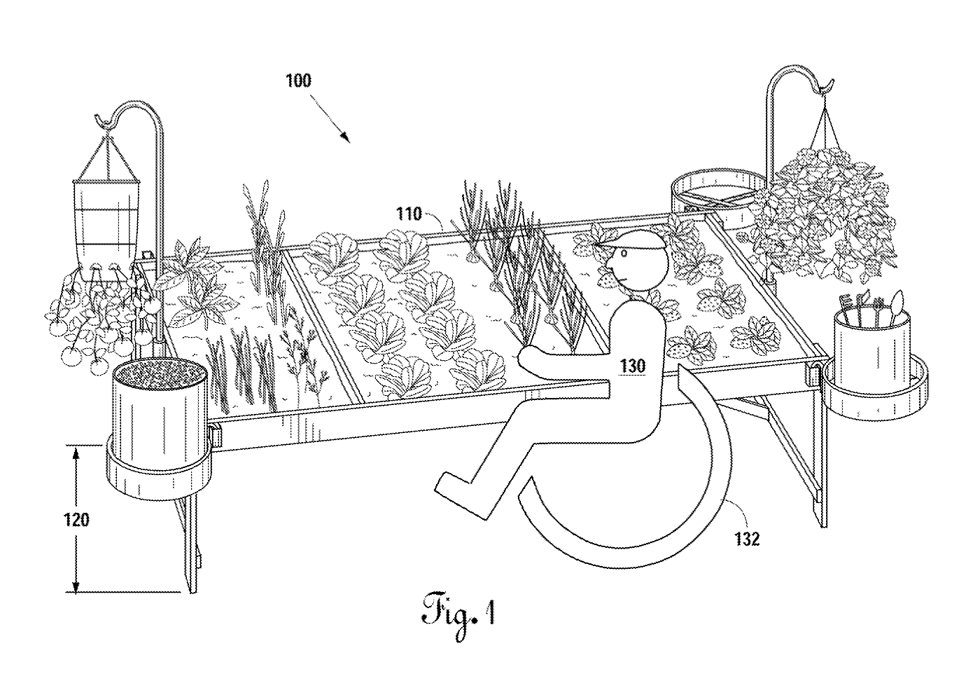

FIG. 1 is a diagrammatic illustration of a specific exemplary embodiment of an elevated garden table of the present disclosure. Gardening system 100 provides elevated garden table 110 having a height 120 off the ground or floor sufficient to accommodate wheelchair gardener 130 so that the legs of a person 130 sitting in a wheelchair 132 fits under the bed of garden table to facilitate access by garden 130 to the gardening bed.

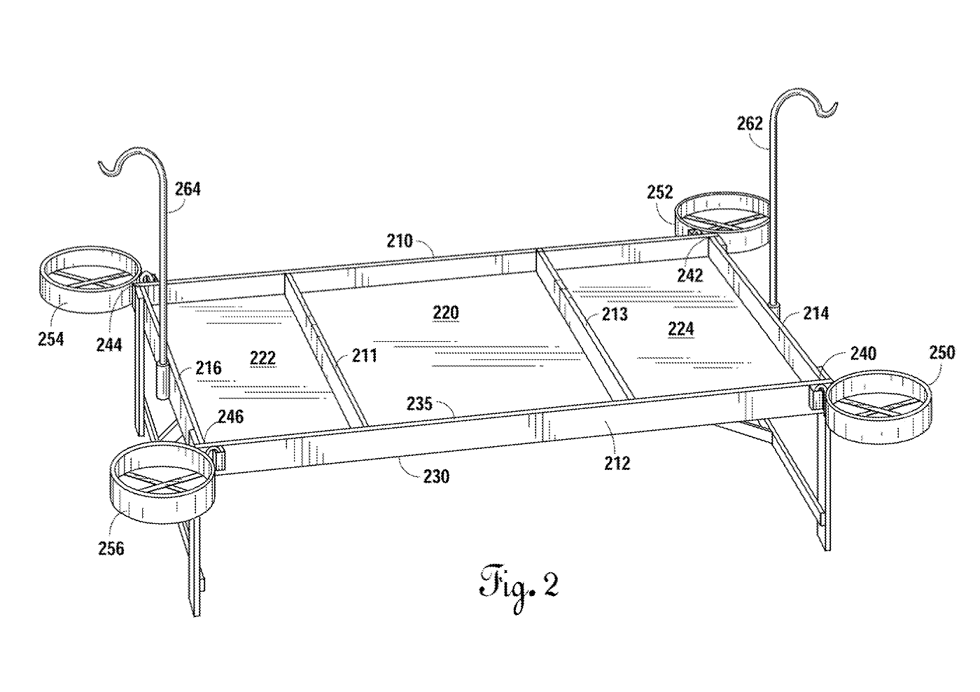

FIG. 2 is a diagrammatic illustration of an alternative top view of the elevated garden table of FIG. 1. Table 110 is partitioned into beds 220, 22, and 224, for example, with partition slats 211 and 213. The beds are further defined by perimeters boards 210, 212, 214 and 216 to form a bed frame. The bottom 230 of table bed 110 and the top 235, define a bed depth for any particular embodiment of a gardening table of the present disclosure. Preferred embodiments provide a bed depth of 6 inches or 7½ inches, depending on the nature and amount of potting soil a gardener prefers to use. Each bed 220, 22, 224 may be filled to an appropriate height with potting soil and the like suitable for the plant that is to be grown in the bed.

The potting beds are further defined by corners 240, 242, 244 and 246. Selectively fastened to the corners are accessory mounts 241 for mounting table accessories such as pot holders 250, 252, 254 and 256. Additional accessories 262 and 264 may also be selective mounted to table 110 in specific embodiments.

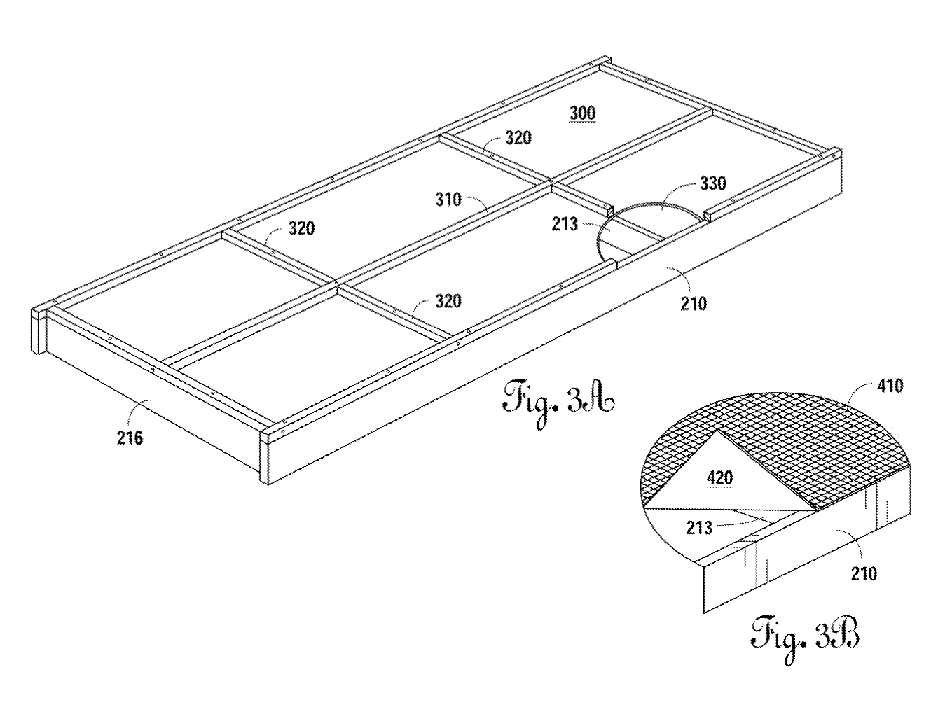

FIG. 3A is a diagrammatic illustration of a bottom view of a specific exemplary embodiment of an elevated garden table of the present disclosure. A particularly advantageous feature of the present gardening table is mesh flooring 300 which extends over the bottom surface area of table 110. A mesh flooring allows drainage of water and other fluids from the potting soil in the beds. Accordingly, plants may be grown directly in the beds of the present table without the necessity of having the plants in pots or other growing containers. Potting soil may be deposited directly into each bed.

Since the floor of the gardening beds is a mesh material fastened to the table around the perimeter with staples, for example, or by some other suitable means, it is preferred to further provide additional bottom structural support with support slats 310 and 320.

FIG. 3B is a blow up cut away illustrating a detail of the table of FIG. 3A. Mesh material 410 underlies one or more layer of weed block screen material 420.

The disclosure of this specification is a description of various specific embodiments and is not intended to limit the present disclosure.

In specific embodiments of the present elevated garden table, two sizes of units are provided—a sixty inches (60″) by (×) thirty-six and five-eighths inches (36⅝″) as well as a eighty-four inches (84″) by (×) thirty-six and five-eighths inches (36⅝″). Alternative embodiments provide a table that with a bed depth of 6 inches and other alternative embodiments provide a table with a 7½ inched bed depth.

Each unit is 34″ tall and each is similar in construction except the end two compartments are twelve inches (12″) smaller in the sixty inch (60″) versus the eighty-four inch (84″) (the drawings in the figures are not to scale). The units are designed to ship the leg assemblies and braces separately in the middle compartment.

For shipping and retail purposes, the table is disassembled and comes with a kit for the owner to assemble the table. Units are designed with the center compartment 220 being the same size to accept leg assemblies and braces to fit flush at the top of the unit, when in place, to allow stacking of units for shipment. A plastic banding strap is wrapped around each unit to reduce wood damage and to keep the strap in place.

Brackets for accessories may be selectively added to each end and on all corners front and back. One accessory is a Pot Holder for deep pots in order to grow deep-rooted plants like tomatoes, bulb onions, carrots, turnips. The other accessory is a Hanger Rod with a hook designed to allow hooking an upside-down tomato plant holder, hanging flower pots, tool buckets, water hoses, etc. Corner bracket is of aluminum and the Pot Holder and Hanger Rod are both made of galvanized steel. Additional accessories include without limitation vertical one or more wire mesh mounted to the bed frame for growing climbing plants and vines or upon which to mount a screen or tarp for protection of the plants from the wind or sun; and sun or wind protectors mounted along a side or side of the bed frame, or to protector mount accessories or as a canopy roof.

Units are preferably constructed of either Treated #1 Pine or Cedar in natural color and can be painted by the buyer or left natural. Cedar material is known as being insect-resistant and more resistant to moisture.

The Treated #1 Pine Garden Unit is constructed of 5/4×6″ treated deck board material with two (2) edges radiused. The base material for the leg assemblies is of #1 Treated Pine 2×4′s.

The Cedar Raised Garden Unit is constructed of 5/4×6″ Cedar boards with two (2) edges radiused. The leg assembly is also constructed of a 2×4 cedar material. All units are screwed together with #8×3″ wood deck screws throughout. Each leg is bolted on with two (2) bolts, washers, nuts and two (2) wood deck screws. Bolts are a ⅜″×3″ carriage-type bolt with washer and nut, all of galvanized material. Holes for bolts and screws are pre-drilled and fitted in construction for easy assembly by the customer. Bolts, washers, nuts and screws for leg assembly and braces will be shipped in a bag with unit including a square head nut driver bit to fit the wood deck screws. Tools required are an electric or battery-type drill motor and a socket or crescent wrench.

The bottom of the unit consists of a screen-like material to hold potting soil and allow water drainage from soil. Screen material is supported by a 2/2 19 ga. Galvanized hardware cloth all stapled from the underside of the unit and supported around the perimeter and through the middle as per drawings with a 1 1/16″×1¾″ rail of either #1 Treated Pine or Cedar. #8×3″ wood deck screws are used to attach bottom rail support about every twelve inches (12″)+/−, for durability and stability.

A small unit measures 36⅝×37″. The unit is designed to ship the legs placed within the bed compartment, as described above, so that units can be stacked. The small unit is adapted to use the same accessories described above of the other sizes.

The Treated #1 Pine Garden Unit is constructed of 5/4×6″ treated deck board material with two (2) edges radiused. The base material for the leg assemblies is of #1 Treated Pine 2×4's.

The Cedar Raised Garden Unit is constructed of 5/4×6″ Cedar boards with two (2) edges radiused. The legs are constructed of a 2×4 cedar material ripped in half. Units are screwed together with #8×3″ wood deck screws throughout. Each leg is bolted on with two (2) bolts, washers, nuts and two (2) wood deck screws. Bolts are a ⅜″×3″ carriage-type bolt with washer and nut, all of galvanized material. Holes for bolts and screws are pre-drilled and fitted in construction for easy assembly by the customer. Bolts, washers, nuts and screws for leg assembly and braces will be shipped in a bag with unit including a square head nut driver bit to fit the wood deck screws. Tools required are an electric or battery-type drill motor and a socket or crescent wrench.

As with the other size units, the bottom of the small unit consists of a screen-like material to hold potting soil and allow water drainage from soil. Screen material is supported by a 2/2 19 ga. galvanized hardware cloth all stapled from the underside of the unit and supported around the perimeter and through the middle as per drawings with a 1 1/16″×1¾″ rail of either #1 Treated Pine or Cedar. #8×3″ wood deck screws are used to attach bottom rail support about every twelve inches (12″)+/−, for durability and stability.

All dimensions may vary a 1/16″+/− due to natural variability in finished wood products due to environmental effects. Kits to assemble a table of the present disclosure are provided with a set of assembly instructions, or assembly instructions are available from the Internet with the web browser. Kits also provide the hardware required to assemble the table, such as screws and bolts, and specific embodiments may also provide additional hardware such as a screw driver and Allen wrench.

Many modifications and other embodiments of the units described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. A table for growing plants, the table comprising:
an elevated bed frame sub-divided into one or more bed and having a bottom;
a mesh floor mounted to the bottom of the bed frame; and
one or more mounts for mounting one or more accessory,
the bed frame being elevated sufficiently for the legs of a person sitting in a wheelchair to fit under the floor of the bed frame.

2. The table of claim 1, further comprising one or more support slats under the mesh floor to support the floor.

3. The table of claim 1, further comprising a canopy for shade mounted to one or more of the accessory mounts.

4. The table of claim 1, wherein the table comprises cedar wood boards.

5. The table of claim 1, wherein the mesh floor further comprises one or more layer of weed block screen.

6. A garden table kit, the kit comprising:
a pre-assembled bed frame having a mesh floor, the bed frame providing at least one bed;
a plurality of disassembled table leg pieces that fit into at least one bed;
one or more accessory mounts;
hardware to assemble the table and accessory mounts; and
instructions that explain how to assemble the table,
wherein, a sufficient number of the leg pieces are long enough that in an assembled tabled the bed frame is elevated sufficiently for the legs of a person sitting in a wheelchair to fit under the floor of the bed frame.

7. The kit of claim 6, further comprising one or more accessory.

8. The kit of claim 6, wherein the kit is stackable.
